(19) United States
(12) Patent Application Publication
(10) Pub. No.: US 2004/0109801 A1
(43) Pub. Date: Jun. 10, 2004

(54) Process for purifying inert gas

(76) Inventors: Kenji Otsuka, Kanagawa (JP); Atsushi Okamoto, Kanagawa (JP); Takeo Komori, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/694,848

(22) Filed: Oct. 29, 2003

(30) Foreign Application Priority Data
Nov. 1, 2002 (JP) 2002-319330

(51) Int. Cl. B01D 53/62

(52) U.S. Cl. 423/210

(57) ABSTRACT

A process for purifying inert gas removing impurities such as oxygen, carbon dioxide and moisture that are contained in inert gas each in a slight amount with the use of reproducible purification agent comprises: manganese oxide (1), and at least one kind of metal oxide (2) selected from vanadium oxide, chromium oxide, iron oxide, tin oxide, zirconium oxide, bismuth oxide, niobium oxide and tantalum oxide as effective component; and preferably further contacting with a synthetic zeolite. The process enables to prevent degradation of the removing capability for impurities even after many returns of reproduction of the purification agent, and to continuously feed highly pure inert gas.

### BACKGROUND OF THE INVENTION

1. Technical Field of the Invention

The present invention relates to a process for purifying inert gas. More particularly, the present invention pertains to a process for purifying inert gas, competently capable of removing impurities such as oxygen, carbon monoxide, carbon dioxide, water, etc., that are contained in inert gas to an extremely low concentration.

2. Prior Art

Inert gases such as helium, nitrogen, argon, etc., are widely used in the semiconductor fabrication industry. Inert gases such as nitrogen, etc., are industrially produced by fractionally distillating liquid air, however, oxygen, carbon dioxide, moisture, etc., in an amount of about several ppm to several hundred ppm are contained in these inert gases. In the field of semiconductor, these inert gases are forcefully required to have an extremely high purity accompanying the progress in film formation technique in recent year. Because of the requirement and a large amount to be used, a development of a process for purifying inert gas capable of continuously feeding highly pure inert gas to a semiconductor production process is seriously demanded.

Various processes for purifying inert gas are developed conventionally, and (1) Japanese Patent Application Laid-Open No. HEI 4-160010 discloses a method of refining rare gas by contacting the gas with a getter agent comprising iron and zirconium to remove impurities in the rare gas. (2) U.S. Pat. No. 5,194,233 discloses a process for purification of rare gas which comprises contacting the rare gas with an alloy getter which consists essentially of vanadium, zirconium and chromium to remove impurities in the rare gas.

Further, (3) U.S. Pat. No. 5,891,220 discloses a process for the purification of chemically inert gas to be purified, containing at least one of oxygen and carbon monoxide as impurities, which comprises: passing the gas to be purified through an adsorbent of hopcalite type comprising at least one porous metal oxide of at least two transition metals comprises a mixed oxide of copper and of manganese.

The reproduction and reuse of the purification agents are preferable not only because they contribute the efficient utilization of resources, but also because they tremendously saves troublesome works such as refilling or pretreatment of the purification agents and highly pure inert gas is easily continuously fed. Still further, (4) Japanese Examined Patent Publication No. Shou 50-6440 discloses a process for purifying inert gas by contacting the gas with a reduced metallic nickel to remove oxygen as impurities contained in the inert gas. In this process, the reproduction of the metallic nickel as the purification agent is possible.

However, the purifying processes with the use of the getter agent disclosed in the foregoing (1) Japanese Patent Application Laid-Open No. HEI 4-160010 and (2) U.S. Pat. No. 5,194,233 have suffered from the disadvantages in that the getter agent generally needed to be heated and in that the running cost of the getter agent was expensive because it was necessary for the getter agent to be replenished caused by the difficulty of reproduction. Further, the purifying processes disclosed in the foregoing (3) U.S. Pat. No. 5,891,220 and (4) Japanese Examined Patent Publication No. Shou 50-6440 have suffered from the disadvantage in that the purification column needed large amount of capacity because the removing capability for impurities, that is, removing amount for impurities per unit amount of the purification agent especially for carbon dioxide, among inert gas is not sufficient. Still further, the purifying process disclosed in the foregoing (3) U.S. Pat. No. 5,891,220 has suffered from the disadvantages in that many returns of reproduction of the purification agent degrade the purification agent.

Under such circumstances, an object of the present invention is to provide a process for purifying inert gas, capable of removing impurities such as oxygen, carbon dioxide, and moisture that are contained in inert gas each in a slight amount to an extremely low concentration, capable of preventing degradation of the removing capability for impurities even after many returns of reproduction of the purification agent, and capable of continuously feeding highly pure inert gas.

The inventors of this invention zealously studied in order to achieve the foregoing object and found that in a process for purifying inert gas with the use of reproducible purification agent, adsorbent, comprises: manganese oxide (1), and at least one kind of metal oxide (2) selected from vanadium oxide, chromium oxide, iron oxide, tin oxide, zirconium oxide, bismuth oxide, niobium oxide and tantalum oxide as effective component extremely improves the removing capability for impurities among inert gas. The foregoing purification agent of inert gas was also found to prevent degradation of the removing capability for impurities even after many returns of reproduction of the purification agent, and to extremely elongate the longevity of the purification agent so that a process for purifying inert gas in the present invention was developed.

It was also found that the foregoing purification agent enables to remove a slight amount of impurities such as oxygen, carbon dioxide and moisture to an extremely low concentration, that a combination of the foregoing purification agent and a synthetic zeolite tremendously elongates a purification period before it requires reproduction in one usage, and that an installment of 2 lines of the purification line provides easy reproduction and shifts of the purification agent with abundant of times. Accordingly, the present invention was completed.

The present invention provides a process for purifying inert gas removing at least one kind of impurities selected from oxygen, carbon dioxide and moisture contained in an inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component

Further, the present invention provides a process for purifying inert gas removing at least one kind of impurities selected from oxygen, carbon dioxide and moisture contained in an inert gas which comprises contacting the inert gas with a purification agent comprises: a manganese oxide, and at least one kind of metal oxide selected from vanadium oxide, chromium oxide, tin oxide, iron oxide, zirconium oxide, bismuth oxide, niobium oxide and tantalum oxide as an effective component; and with a synthetic zeolite.

Furthermore, the present invention provides a process for purifying inert gas removing at least one kind of impurities selected from oxygen, carbon dioxide and moisture contained in the inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component; and further reproducing the purification agent by contacting a reproduction gas with the purification agent.

Still further, the present invention provides a process for purifying inert gas removing at least one kind of impurities selected from oxygen, carbon dioxide and moisture contained in the inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component; and with a synthetic zeolite; further reproducing the purification agent and the synthetic zeolite by contacting a reproduction gas with the purification agent and the synthetic zeolite.

### BRIEF DESCRIPTION OF THE DRAWINGS

FIG. 1 is a schematic illustration showing an embodiment of a purification line to carry out a process for purifying inert gas according to the present invention;

FIG. 2 is a schematic illustration showing another embodiment of a purification line to carry out a process for purifying inert gas according to the present invention; and

FIG. 3 is a schematic illustration showing an embodiment of a purification apparatus to carry out a process for purifying inert gas according to the present invention.

### DESCRIPTION OF THE PREFERRED EMBODIMENTS

The present invention is applied to the removal of oxygen, carbon dioxide and moisture that are contained as impurities in inert gas. A process for purifying inert gas of the present invention particularly reveals effect in the viewpoint of remarkably elongating longevity of a purification agent employed for purifying inert gas.

The present invention provides a process for purifying inert gas removing impurities contained in the inert gas which comprises contacting the inert gas with a purification agent comprises: a manganese oxide (1), and at least one kind of metal oxide (2) selected from vanadium oxide, chromium oxide, iron oxide, tin oxide, zirconium oxide, bismuth oxide, niobium oxide and tantalum oxide as an effective component and preferably further contacting the inert gas with a synthetic zeolite.

Further, the present invention provides a process for purifying inert gas removing impurities contained in the inert gas which comprises contacting the inert gas with a purification agent comprises: a manganese oxide (1), and at least one kind of metal oxide (2) selected from vanadium oxide, chromium oxide, iron oxide, tin oxide, zirconium oxide, bismuth oxide, niobium oxide and tantalum oxide as an effective component; and preferably further contacting the inert gas with at least one of a purification agent or a synthetic zeolite and then, reproducing at least one of the purification agent or the synthetic zeolite by contacting a reproduction gas with them.

The manganese oxide employed as the effective component of the purification agent in the present invention is MnO, Mn₃O₄, Mn₂O₃, MnO₂ or the like. In the present invention, its production process does not restrict the manganese oxide, and it has a BET specific surface area preferably in the range of 10 to 500 m²/g. The use of a manganese oxide having a BET specific surface area smaller than 10 m²/g causes a fear of decrease in the amount of removed impurities per unit amount of the purification agent. Conversely, the use thereof having a BET specific surface area larger than 500 m²/g enables efficient removal of impurities, however, the industrial production of it is difficult.

These manganese oxides may be produced from marketed products for use as such, or may be produced by a well-known process. With regard to the process for producing manganese oxide, MnO is produced, for instance, by heating MnCO₃ or Mn(OH)₂ at around 500° C. in the absence of oxygen or by reducing a higher-grade manganese oxide in a stream of H₂ or CO. Mn₃O₄ is readily produced by igniting a manganese-containing compound (an oxide, hydroxide, sulfite or carbonate thereof) at around 1000° C. in the air or in a stream of oxygen. Mn₂O₃ is produced, for instance, by heating a manganese salt excluding a sulfate thereof at 600 to 800° C. in the air. MnO₂ is produced by stirring and mixing dilute aqueous solution of potassium permanganate, dilute aqueous solution of manganese sulfate and concentrated sulfuric acid under heating, washing the resultant precipitate, and drying the same.

Moreover, in the process for purifying inert gas of the present invention, vanadium oxide, chromium oxide, iron oxide, tin oxide, zirconium oxide, bismuth oxide, niobium oxide, tantalum oxide employed as the effective component of the purification agent aside from manganese oxide is VO, V₂O₃, VO₂, V₂O₅, CrO, Cr₂O₃, CrO₂, Cr₂O₅, CrO₃, FeO, Fe₃O₄, Fe₂O₃, SnO, SnO₂, ZrO₂, BiO, Bi₂O₃, Bi₂O₄, Bi₂O₅, NbO, Nb₂O₃, NbO₂, Nb₂O₅, TaO, Ta₂O₃, TaO₂, Ta₂O₅, respectively. Among these metal oxides, it is particularly desirable to employ vanadium oxide, chromium oxide or tin oxide in the viewpoint of elevated capability of removing impurities in the inert gas. In the present invention, similarly with the manganese oxide, its production process does not restrict the metal oxide, and it has a BET specific surface area preferably in the range of 10 to 500 m²/g. These metal oxides may be produced from marketed products for use as such, or may be produced by a well-known process.

The purification agent in the process for purifying inert gas of the present invention is prepared so that the ratio (Mn/(Mn+V+Cr+Fe+Sn+Zr+Bi+Nb+Ta)) between a number of manganese atom and a number of the entire metallic atoms of the effective component is usually 50 to 99%, preferably 80 to 99%, and more preferably 86 to 98%. When the ratio between a number of manganese atom and a number of the entire metallic atoms of the effective component is smaller than 50% or when the ratio exceeds 99%, not only the capability of removing impurities in the inert gas decreases but also the purification agent itself degrades in each reproduction process of itself thereby further decreases the capability of removing impurities in the inert gas.

The purification agent in the present invention may be usually prepared by mixing aqueous solution including Mn and aqueous solution of sulfuric acid including at least one kind selected from V, Cr, Fe, Sn, Zr, Bi, Nb and Ta beforehand, coprecipitating the manganese oxide and the metal oxide of the foregoing metals, filtering the precipitate and further drying, or may be prepared by mixing and pelletizing each effective component.

It is preferable in the case of producing the purification agent to add a binder at the time of preparing the same in order to enhance the molding ability and molding strength of the purification agent. The binder is exemplified by alumina sol, silica sol and the like. The amount of the binder, when added, is at most 10% by weight, based on the total weight of the purification agent, preferably at most 5% by weight based thereon. An impurity component other than the effective component such as metals other than the foregoing metals and an oxide thereof may be incorporated in a small amount, however, the content of the effective component is usually at least 70% by weight in the entire purification agents, preferably at least 90% by weight based thereon.

The shape, form and size of the purification agent are not specifically limited. The foregoing purification agent may be spherical, columnar, cylindrical or granular. It has a diameter of approximately 0.5 to 10 mm for spherical form; a diameter of approximately 0.5 to 10 mm and a height of approximately 2 to 20 mm for a columnar form such as pellet and tablet; and a mesh opening of approximately 0.84 to 5.66 mm for irregular form such as granule. The filling density of the purification agent, when filled in a purification column, varies depending upon the shape and preparation method, and is usually 0.4 to 2.0 g/milliliter approximately.

In the process for purifying inert gas according to the present invention, the purification agent comprising a manganese oxide, and at least one kind of metal oxide selected from vanadium oxide, chromium oxide, iron oxide, tin oxide, zirconium oxide, bismuth oxide, niobium oxide and tantalum oxide as an effective component is, prior to use, usually subjected to hydrogen reduction for the purpose of activation. The reduction can be put into practice by passing, for instance, a mixed gas of hydrogen and nitrogen at the temperature of 350° C. or lower at superficial linear velocity (LV) of approximately 5 cm/second.

The synthetic zeolite employed for the process for purifying ammonia according to the present invention is, from chemical aspect, the synthetic zeolite, for instance, in which the sodium segment of a hydrated sodium salt of synthetic crystalline aluminosilicate is replaced in part with potassium. The crystalline synthetic zeolite is characterized by its having in the inside of crystals, a large number of pores that are almost uniform in pore size. The synthetic zeolite is usually molded into a spherical form having a mesh size of 4 to 20, a columnar form having a diameter of 1.5 to 4 mm and a height of 5 to 20 mm or the like so that it can be effectively used. It is desirable to employ the synthetic zeolite that has a pore diameter in the range of 3 to 10 Å or equivalent in the process for purifying inert gas of the present invention. Marketed synthetic zeolite that meets the foregoing requirements is exemplified by Molecular Sieves 3A, 4A, 5A and 13X (available from Union Carbide Corporation in U.S.A. or Union Showa Co., Ltd.). Prior to use, the synthetic zeolite is usually activated at the temperature of about 150 to 350° C., in a stream of an inert gas.

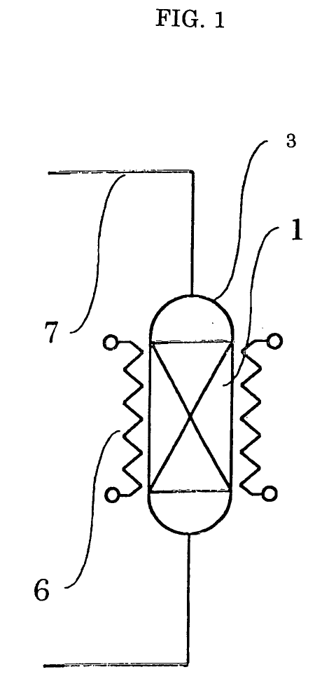

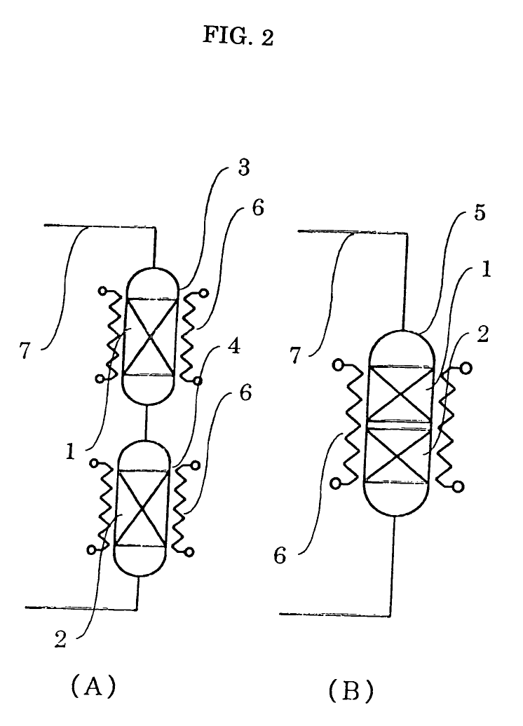

In the case where only the purification agent comprising a manganese oxide, and at least one kind of metal oxide selected from vanadium oxide, chromium oxide, iron oxide, tin oxide, zirconium oxide, bismuth oxide, niobium oxide and tantalum oxide as an effective component is used, the process for purifying inert gas is usually carried out, in a purification line as shown in FIG. 1, after filling the purification agent 1 into purification column 3 and after subjecting reduction treatment, by passing inert gas through purification column 3. In the case where both the purification agent and the synthetic zeolite are used, the process for purifying inert gas is usually carried out, either in a purification line as shown in FIG. 2(A), after filling the purification agent 1 into purification column 3 and filling the synthetic zeolite 2 into adsorption column 4 and after subjecting reduction treatment, by passing inert gas through purification column 3 and adsorption column 4, or in a purification line as shown in FIG. 2(B), after filling the purification agent 1 and the synthetic zeolite 2 into treatment column 5 and after subjecting reduction treatment, by passing inert gas through purification column 5. In FIGS. 1 and 2, numerical symbol 6 indicates a heater and numerical symbol 7 indicates feed line for inert gas. In the process for purifying inert gas according to the present invention, the purification agent principally removes oxygen, carbon monoxide, carbon dioxide and moisture; and the synthetic zeolite principally removes carbon dioxide and moisture. The concentration of these impurities contained in the inert gas to which the process according to the present invention is applied is usually 100 ppm or lower.

In general, a filling length of 50 to 1500 mm is applied practically to all of the filling length of the purification agent filled in the purification column, the filling length of the synthetic zeolite filled in the adsorption column or the filling length of the purification agent and the synthetic zeolite filled in the treatment column. A filling length shorter than 50 mm causes a fear of deteriorating the removal ratio of impurities, whereas a filling length longer than 1500 mm causes a fear of excessive pressure loss. The superficial linear velocity (LV) of the inert gas at the time of purification varies depending upon the concentration of impurities in the inert gas, operational conditions and the like, and thus cannot be unequivocally specified, but it is usually at most 100 cm/second, preferably at most 30 cm/second.

The temperature of contacting inert gas with the purification agent is 150° C. or lower as expressed by the temperature of the gas supplied to the inlet of the purification column, usually is an ordinary temperature without requiring heating or cooling. Similarly, the temperature of contacting inert gas with the synthetic zeolite is usually is an ordinary temperature. The pressure of contacting inert gas with the purification agent or the synthetic zeolite is not specifically restricted. The present process can be put into practice by any of an atmospheric pressure, a reduced pressure such as 1 KPa or an elevated pressure such as 0.5 MPa (absolute pressure), but usually at a pressure between an atmospheric pressure and an elevated pressure of 0.3 MPa (absolute pressure).

In the process for purifying inert gas according to the present invention, a reproduction of the purification agent comprising a manganese oxide, and at least one kind of metal oxide selected from vanadium oxide, chromium oxide, iron oxide, tin oxide, zirconium oxide, bismuth oxide, niobium oxide and tantalum oxide as an effective component is usually carried out by hydrogen reduction reduction. The reduction may be carried out at the temperature of 150 to 400° C. by passing mixed gas of hydrogen and inert gas, however, it is preferable that after supplying the inert gas, feeding hydrogen under the foregoing condition in the viewpoint of elongating the longevity of the purification agent.

Further, a reproduction of the synthetic zeolite is carried out by passing the inert gas approximately at the temperature of 150 to 350° C.

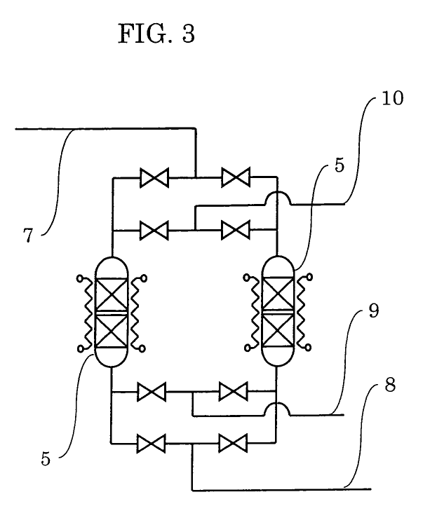

In the process for purifying inert gas according to the present invention, it is preferable that the purification of inert gas is intermittently carried out by deploying at least two lines of either a purification line containing both the purification agent and the synthetic zeolite or a purification line containing only the purification agent in order to easily supplying high purity inert gas continuously. FIG. 3 illustrates an embodiment of a purification apparatus provided for the foregoing application. In FIG. 3, numerical symbol 5 indicates treatment column, numerical symbol 7 indicates feed line for inert gas, numerical symbol 8 indicates drawing line for purified inert gas, numerical symbol 9 indicates feed line for reproduction gas, and numerical symbol 10 indicates exhaust line for reproduced exhaust gas. With the use of the purification apparatus, switchingly employing one purification line of the foregoing at least two lines in turns, feeding and purifying the inert gas, the reproduction of the purification agent and synthetic zeolite is made possible by simultaneously feeding the reproduction gas to the line after the purification. Accordingly, the continuous supply of the high purity inert gas may be easily achieved.

### EXAMPLES

In the following examples are described several preferred embodiments to concretely illustrate the invention, however, it is to be understood that the invention is not intended to be limited to the specific embodiments.

### Example 1

(Preparation of Purification Agent)

To an aqueous solution of 395 g of potassium permanganate and 76.7 g of potassium metavanadate in 12.5 kg of water were promptly added a mixed solution of 15.1 kg of aqueous solution of manganese sulfate in 3% by weight concentration and 144 g of concentrated sulfuric acid to proceed with reaction at the temperature of 70° C. The resultant precipitate was agitated at the temperature of 90° C. for 3 hours, filtered, washed with 25 kg of ion exchanged water three times, filtered again to obtain 1240 g of cakey manganese oxide (MnO₂) and vanadium oxide (V₂O₅). The resultant cakey mixed product was dried at the temperature of 90° C. for 12 hours to obtain 380 g of powdery mixed product. The BET specific surface area of the resultant powdery mixed product measured by means of gas adsorption quantity measuring instrument (“Autosorb 3B” produced by Yuasa Ionics Inc.) was 227 m²/g.

To the resultant powdery mixed product in an amount of 100 g were added under kneading 2 g of alumina sol and 40 g of water to obtain a cake, which was extruded with an extruder to obtain a molded product having a diameter of 1.6 mm. The resultant molded product was cut into pieces of about 10 mm in length to obtain pellets. The resultant pellets were dried at the temperature of 120° C. for 12 hours to obtain purification agent. The ratio between a number of manganese atoms and a number of the entire metallic atoms of the effective component (manganese oxide and vanadium oxide) among the resultant purification agent was 90% and the moisture content among the purification agent was 0.6% by weight.

(Purification Test of Inert Gas)

The foregoing purification agent was filled in a stainless steel-made purification column having an inside diameter of 45.2 mm and a length of 200 mm so that the filling length was made to be 150 mm. Subsequently, the temperature of the purification agent was raised to 250° C., a mixed gas of hydrogen and nitrogen (5% by volume of hydrogen and 95% by volume of nitrogen) was passed therethrough for 5 hours under atmospheric pressure and at a flow rate of 2887 milliliter/minute (LV of 3.0 cm/second) to effect reduction treatment of the purification agent, and thereafter the purification agent was cooled down to ordinary temperature.

Consecutively, nitrogen purification was put into practice by passing nitrogen as the inert gas containing 50 ppm of oxygen as impurities through the purification column at ordinary temperature (20° C.) with a flow rate of 9622 milliliter/minute (LV of 10 cm/second). Measurements were made of the concentrations of oxygen in the outlet treated gas by means of an atmospheric pressure ionization mass spectrometry instrument (API-MS, detectable lower limit concentration of 1 ppb) at intervals of about 20 minutes until oxygen was detected. The amount (milliliter) of oxygen removal per 1 g of the purification agent was obtained by the foregoing procedure. The results are described in Table 1.

After the detection of oxygen, feeding of inert gas was discontinued and the temperature of the purification agent was raised to 250° C. Then, reproduction of the purification agent was put into practice by passing nitrogen under atmospheric pressure with a flow rate of 2887 milliliter/minute (LV of 3.0 cm/second) for 1 hour and further passing mixed gas of hydrogen and nitrogen (5% by volume of hydrogen and 95% by volume of nitrogen) under atmospheric pressure with flow rate of 2887 milliliter/minute (LV of 3.0 cm/second) for 5 hours. Consecutively, the purification agent was cooled down to the ordinary temperature, and thereafter, nitrogen purification was started again. The foregoing procedures were carried out repeatedly, and the amount (milliliter) of oxygen removal per 1 g of the purification agent was obtained in each procedure. The results are described in Table 1.

### Examples 2 to 4

Purification agent were prepared in a similar manner as Example 1 except that the ratio between a number of manganese atom and a number of the entire metallic atoms of the effective component among the resultant purification agent was changed to 50%, 70% or 95% respectively in Examples 2 to 4.

Inert gas purification tests were carried out in the same manner as Example 1 except that the foregoing purification agents were employed in Examples 2 to 4. The results are described in Table 1.

### Example 5

Inert gas purification test was carried out in a similar manner as Example 1 except that nitrogen containing 50 ppm of carbon dioxide as impurities was employed as the inert gas in Example 5. The results are described in Table 1.

### Examples 6 to 8

Purification agent were prepared in a similar manner as Example 1 except that the ratio between a number of manganese atom and a number of the entire metallic atoms of the effective component among the resultant purification agent was changed to 50%, 70% or 95% respectively in Examples 6 to 8.

Inert gas purification tests were carried out in the same manner as Example 5 except that the foregoing purification agents were employed in Examples 6 to 8. The results are described in Table 1.

### Example 9

Inert gas purification tests were carried out in the same manner as Example 1 except that nitrogen containing 50 ppm of moisture as impurities was employed as the inert gas in Example 9. The results are described in Table 1.

### Examples 10 to 12

Purification agent were prepared in a similar manner as Example 1 except that the ratio between a number of manganese atom and a number of the entire metallic atoms of the effective component among the resultant purification agent was changed to 50%, 70% or 95% respectively in Examples 10 to 12.

Inert gas purification tests were carried out in the same manner as Example 9 except that the foregoing purification agents were employed in Examples 10 to 12. The results are described in Table 1.

TABLE 1
Purification Agent: Manganese Oxide, Vanadium Oxide

| | | | Removed Amount by | | | | |
|---|---|---|---|---|---|---|---|
| | Ratio of | | Purifcation Agent (ml/g) | | | | |
| | Mn atom | Impurities | First | Second | Third | Fifth | Tenth |
| Ex. 1 | 90% | O₂ | 13.7 | 12.1 | 12.1 | 12.0 | 12.0 |
| Ex. 2 | 50% | O₂ | 7.7 | 7.0 | 6.9 | 6.9 | 6.9 |
| Ex. 3 | 70% | O₂ | 9.4 | 8.6 | 8.5 | 8.5 | 8.4 |
| Ex. 4 | 95% | O₂ | 11.9 | 10.9 | 10.9 | 10.9 | 10.8 |
| Ex. 5 | 90% | CO₂ | 10.3 | 8.8 | 8.8 | 8.7 | 8.6 |
| Ex. 6 | 50% | CO₂ | 5.6 | 4.9 | 4.8 | 4.8 | 4.8 |
| Ex. 7 | 70% | CO₂ | 7.4 | 6.9 | 6.9 | 6.8 | 6.7 |
| Ex. 8 | 95% | CO₂ | 8.0 | 7.2 | 7.2 | 7.1 | 7.1 |
| Ex. 9 | 90% | H₂O | 5.1 | 4.5 | 4.5 | 4.5 | 4.5 |
| Ex. 10 | 50% | H₂O | 3.3 | 3.0 | 2.9 | 2.9 | 2.9 |
| Ex. 11 | 70% | H₂O | 4.4 | 3.9 | 3.8 | 3.8 | 3.8 |
| Ex. 12 | 95% | H₂O | 4.6 | 4.1 | 4.1 | 4.1 | 4.1 |

### Example 13

(Preparation of Purification Agent)

To an aqueous solution of 395 g of potassium permanganate and 108 g of potassium chromate in 12.5 kg of water were promptly added a mixed solution of 15.1 kg of aqueous solution of manganese sulfate in 3% by weight concentration and 144 g of concentrated sulfuric acid to proceed with reaction at the temperature of 70° C. The resultant precipitate was agitated at the temperature of 90° C. for 3 hours, filtered, washed with 25 kg of ion exchanged water three times, filtered again to obtain 1230 g of cakey manganese oxide (MnO₂) and chromium oxide (CrO₃). The resultant cakey mixed product was dried at the temperature of 90° C. for 12 hours to obtain 390 g of powdery mixed product. The BET specific surface area of the resultant powdery mixed product measured by means of gas adsorption quantity measuring instrument (“Autosorb 3B” produced by Yuasa Ionics Inc.) was 225 m²/g.

To the resultant powdery mixed product in an amount of 100 g were added under kneading 2 g of alumina sol and 40 g of water to obtain a cake, which was extruded with an extruder to obtain a molded product having a diameter of 1.6 mm. The resultant molded product was cut into pieces of about 10 mm in length to obtain pellets. The resultant pellets were dried at the temperature of 120° C. for 12 hours to obtain purification agent. The ratio between a number of manganese atoms and a number of the entire metallic atoms of the effective component (manganese oxide and chromium oxide) among the resultant purification agent was 90% and the moisture content among the purification agent was 0.6% by weight.

(Purification Test of Inert Gas)

Ammonia purification test was carried out in the same manner as Example 1 except that the foregoing purification agent containing manganese oxide and chromium oxide as the effective component was employed in Example 13. The results are described in Table 2.

### Examples 14 to 16

Purification agent were prepared in a similar manner as Example 13 except that the ratio between a number of manganese atom and a number of the entire metallic atoms of the effective component among the resultant purification agent was changed to 50%, 70% or 95% respectively in Examples 14 to 16.

Inert gas purification tests were carried out in the same manner as Example 13 except that the foregoing purification agents were employed in Examples 14 to 16. The results are described in Table 2.

### Example 17

Inert gas purification tests were carried out in the same manner as Example 13 except that nitrogen containing 50 ppm of carbon dioxide as impurities was employed as the inert gas in Example 17. The results are described in Table 2.

### Examples 18 to 20

Purification agent were prepared in a similar manner as Example 13 except that the ratio between a number of manganese atom and a number of the entire metallic atoms of the effective component among the resultant purification agent was changed to 50%, 70% or 95% respectively in Examples 18 to 20.

Inert gas purification tests were carried out in the same manner as Example 17 except that the foregoing purification agents were employed in Examples 18 to 20. The results are described in Table 2.

### Example 21

Inert gas purification tests were carried out in the same manner as Example 13 except that nitrogen containing 50 ppm of moisture as impurities was employed as the inert gas in Example 21. The results are described in Table 2.

### Examples 22 to 24

Purification agent were prepared in a similar manner as Example 13 except that the ratio between a number of manganese atom and a number of the entire metallic atoms of the effective component among the resultant purification agent was changed to 50%, 70% or 95% respectively in Examples 22 to 24.

Inert gas purification tests were carried out in the same manner as Example 21 except that the foregoing purification agents were employed in Examples 22 to 24. The results are described in Table 2.

TABLE 2
Purification Agent: Manganese Oxide, Chromium Oxide

| | | | Removed Amount by | | | | |
|---|---|---|---|---|---|---|---|
| | Ratio of | | Purifcation Agent (ml/g) | | | | |
| | Mn atom | Impurities | First | Second | Third | Fifth | Tenth |
| Ex. 13 | 90% | O₂ | 12.5 | 10.8 | 10.8 | 10.8 | 10.7 |
| Ex. 14 | 50% | O₂ | 6.6 | 5.8 | 5.8 | 5.7 | 5.7 |
| Ex. 15 | 70% | O₂ | 8.1 | 7.1 | 7.0 | 7.0 | 7.0 |
| Ex. 16 | 95% | O₂ | 10.9 | 9.7 | 9.7 | 9.6 | 9.6 |
| Ex. 17 | 90% | CO₂ | 9.6 | 8.8 | 8.7 | 8.7 | 8.7 |
| Ex. 18 | 50% | CO₂ | 5.2 | 4.6 | 4.6 | 4.5 | 4.5 |
| Ex. 19 | 70% | CO₂ | 7.4 | 6.8 | 6.8 | 6.8 | 6.7 |
| Ex. 20 | 95% | CO₂ | 7.1 | 6.2 | 6.2 | 6.1 | 6.1 |
| Ex. 21 | 90% | H₂O | 4.8 | 4.2 | 4.2 | 4.2 | 4.2 |
| Ex. 22 | 50% | H₂O | 3.0 | 2.5 | 2.5 | 2.5 | 2.4 |
| Ex. 23 | 70% | H₂O | 3.9 | 3.2 | 3.2 | 3.2 | 3.1 |
| Ex. 24 | 95% | H₂O | 4.2 | 3.6 | 3.6 | 3.6 | 3.6 |

### Example 25

(Preparation of Purification Agent)

Potassium permanganate, manganese sulfate aqueous solution, and iron sulfate aqueous solution were mixed in a similar manner as Example 1 and were coprecipitated. The resultant precipitate was filtered and dried in a similar manner as Example 1 to obtain powdery mixed product in Example 25. To the resultant powdery mixed product was added alumina sol and water under kneading to obtain a cake, which was extruded with an extruder to obtain a molded product, and cut into pieces to obtain pellets. The resultant pellets were dried at the temperature of 120° C. for 12 hours to obtain purification agent. The ratio between a number of manganese atoms and a number of the entire metallic atoms of the effective component (manganese oxide and iron oxide) among the resultant purification agent was 90% and the moisture content among the purification agent was 0.8% by weight.

(Purification Test of Inert Gas)

Inert gas purification tests were carried out by the use of the foregoing purification agent containing manganese oxide and iron oxide as effective components in a similar manner as Example 1 except that argon containing 50 ppm of carbon dioxide as impurities was employed as the inert gas in Example 25. The results are described in Table 3.

### Examples 26 to 28

Purification agent were prepared in a similar manner as Example 25 except that the ratio between a number of manganese atom and a number of the entire metallic atoms of the effective component among the resultant purification agent was changed to 50%, 70% or 95% respectively in Examples 26 to 28.

Inert gas purification tests were carried out in the same manner as Example 25 except that the foregoing purification agents were employed in Examples 26 to 28. The results are described in Table 3.

TABLE 3
Purification Agent: Manganese Oxide, Iron Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 25 | 90% | CO₂ | 4.3 | 3.4 | 3.4 | 3.4 | 3.4 |
| Ex. 26 | 50% | CO₂ | 2.6 | 1.9 | 1.9 | 1.9 | 1.9 |
| Ex. 27 | 70% | CO₂ | 3.7 | 3.1 | 3.1 | 3.1 | 3.1 |
| Ex. 28 | 95% | CO₂ | 3.9 | 3.3 | 3.3 | 3.3 | 3.3 |

### Examples 29 to 32

Purification agent were prepared in a similar manner as Example 1 except that the purification agent contained manganese oxide and tin oxide as effective components, and the ratio between a number of manganese atom and a number of the entire metallic atoms of the effective component among the resultant purification agent was changed to 50%, 70% or 95% respectively in Examples 29 to 32. Inert gas purification tests were carried out by the use of these purification agents in a similar manner as Example 1 except that helium containing 50 ppm of carbon dioxide was purified in Examples 29 to 32. The results are described in Table 4.

TABLE 4
Purification Agent: Manganese Oxide, Tin Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 29 | 90% | CO₂ | 8.7 | 7.9 | 7.9 | 7.8 | 7.8 |
| Ex. 30 | 50% | CO₂ | 5.6 | 5.1 | 5.1 | 5.1 | 5.1 |
| Ex. 31 | 70% | CO₂ | 6.9 | 6.3 | 6.3 | 6.3 | 6.2 |
| Ex. 32 | 95% | CO₂ | 7.3 | 6.9 | 6.8 | 6.8 | 6.8 |

### Examples 33 to 36

Purification agent were prepared in a similar manner as Example 1 except that the purification agent contained manganese oxide and zirconium oxide as effective components, and the ratio between a number of manganese atom and a number of the entire metallic atoms of the effective component among the resultant purification agent was changed to 50%, 70%, 90% or 95% respectively in Examples 33 to 36. Inert gas purification tests were carried out by the use of these purification agents in a similar manner as Example 1 except that nitrogen containing 50 ppm of carbon dioxide was purified in Examples 33 to 36. The results are described in Table 5.

TABLE 5
Purification Agent: Manganese Oxide, Zirconium Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 33 | 90% | CO₂ | 8.2 | 7.5 | 7.5 | 7.4 | 7.4 |
| Ex. 34 | 50% | CO₂ | 5.1 | 4.8 | 4.8 | 4.8 | 4.8 |
| Ex. 35 | 70% | CO₂ | 6.3 | 5.9 | 5.9 | 5.9 | 5.9 |
| Ex. 36 | 95% | CO₂ | 7.0 | 6.5 | 6.5 | 6.5 | 6.5 |

### Examples 37 to 40

Purification agent were prepared in a similar manner as Example 1 except that the purification agent contained manganese oxide and bismuth oxide as effective components, and the ratio between a number of manganese atom and a number of the entire metallic atoms of the effective component among the resultant purification agent was changed to 50%, 70%, 90% or 95% respectively in Examples 37 to 40. Inert gas purification tests were carried out by the use of these purification agents in a similar manner as Example 1 except that nitrogen containing 50 ppm of carbon dioxide was purified in Examples 37 to 40. The results are described in Table 6.

TABLE 6
Purification Agent: Manganese Oxide, Bismuth Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 37 | 90% | CO₂ | 6.4 | 5.7 | 5.7 | 5.7 | 5.7 |
| Ex. 38 | 50% | CO₂ | 3.4 | 2.9 | 2.9 | 2.9 | 2.9 |
| Ex. 39 | 70% | CO₂ | 4.9 | 4.5 | 4.4 | 4.4 | 4.4 |
| Ex. 40 | 95% | CO₂ | 5.7 | 5.2 | 5.2 | 5.2 | 5.1 |

### Examples 41 to 44

Purification agent were prepared in a similar manner as Example 1 except that the purification agent contained manganese oxide and niobium oxide as effective components, and the ratio between a number of manganese atom and a number of the entire metallic atoms of the effective component among the resultant purification agent was changed to 50%, 70%, 90% or 95% respectively in Examples 41 to 44. Inert gas purification tests were carried out by the use of these purification agents in a similar manner as Example 1 except that nitrogen containing 50 ppm of carbon dioxide was purified in Examples 41 to 44. The results are described in Table 7.

TABLE 7
Purification Agent: Manganese Oxide, Niobium Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 41 | 90% | CO₂ | 4.5 | 4.0 | 4.0 | 4.0 | 3.9 |
| Ex. 42 | 50% | CO₂ | 2.9 | 2.5 | 2.5 | 2.5 | 2.5 |
| Ex. 43 | 70% | CO₂ | 4.1 | 3.6 | 3.6 | 3.6 | 3.6 |
| Ex. 44 | 95% | CO₂ | 4.2 | 3.8 | 3.8 | 3.8 | 3.7 |

### Examples 45 to 48

Purification agent were prepared in a similar manner as Example 1 except that the purification agent contained manganese oxide and tantalum oxide as effective components, and the ratio between a number of manganese atom and a number of the entire metallic atoms of the effective component among the resultant purification agent was changed to 50%, 70%, 90% or 95% respectively in Examples 45 to 48. Inert gas purification tests were carried out by the use of these purification agents in a similar manner as Example 1 except that nitrogen containing 50 ppm of carbon dioxide was purified in Examples 45 to 48. The results are described in Table 8.

TABLE 8
Purification Agent: Manganese Oxide, Tantalum Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 45 | 90% | CO₂ | 4.6 | 4.1 | 4.1 | 4.1 | 4.1 |
| Ex. 46 | 50% | CO₂ | 3.1 | 2.6 | 2.6 | 2.5 | 2.5 |
| Ex. 47 | 70% | CO₂ | 4.2 | 3.8 | 3.8 | 3.7 | 3.7 |
| Ex. 48 | 95% | CO₂ | 4.4 | 3.9 | 3.9 | 3.9 | 3.9 |

### Examples 49 to 52

Purification agent were prepared in a similar manner as Example 1 except that the purification agent contained manganese oxide, vanadium oxide and chromium oxide as effective components, and the ratio between a number of manganese atom and a number of the entire metallic atoms of the effective component among the resultant purification agent was changed to 50%, 70%, 90% or 95% respectively in Examples 49 to 52. The numbers of vanadium atoms and chromium atoms were equal. Inert gas purification tests were carried out by the use of these purification agents in a similar manner as Example 1 except that nitrogen containing 50 ppm of carbon dioxide was purified in Examples 49 to 52. The results are described in Table 9.

TABLE 9
Purification Agent: Manganese Oxide,
Vanadium Oxide, Chromium Oxide

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 49 | 90% | CO₂ | 10.1 | 9.1 | 9.1 | 9.1 | 9.1 |
| Ex. 50 | 50% | CO₂ | 5.5 | 4.9 | 4.9 | 4.9 | 4.9 |
| Ex. 51 | 70% | CO₂ | 6.5 | 5.8 | 5.8 | 5.8 | 5.8 |
| Ex. 52 | 95% | CO₂ | 7.9 | 7.1 | 7.1 | 7.0 | 6.9 |

### Example 53

The purification agent employed in Example 1 was filled in a stainless steel-made treatment column having an inside diameter of 45.2 mm and a length of 400 mm so that the filling length was made to be 150 mm. Further, marketed synthetic zeolite having a pore diameter of 4 Å or equivalent (Molecular Sieves 4A, available from Union Carbide Corporation) was filled in the downstream of the purification agent so that the filling length was made to be 150 mm. Subsequently, the temperature of the purification agent was raised to 250° C., a mixed gas of hydrogen and nitrogen (5% by volume of hydrogen and 95% by volume of nitrogen) was passed from the side of the synthetic zeolite therethrough for 5 hours under atmospheric pressure and at a flow rate of 2887 milliliter/minute (LV of 3.0 cm/second) to effect reduction treatment of the purification agent, and thereafter the purification agent was cooled down to ordinary temperature. Further, the temperature of the synthetic zeolite was raised to 350° C., a nitrogen gas was passed from side of the purification agent therethrough for 4 hours under atmospheric pressure and at a flow rate of 2887 milliliter/minute (LV of 3.0 cm/second) to effect activation treatment of the synthetic zeolite, and thereafter the synthetic zeolite was cooled down to ordinary temperature.

Consecutively, nitrogen containing 50 ppm of oxygen as impurities was passed through the treatment column at ordinary temperature (20° C.) with a flow rate of 9622 milliliter/minute (LV of 10 cm/second) to carry out inert gas purification. Measurements were made of the concentrations of oxygen in the outlet treated gas by means of an atmospheric pressure ionization mass spectrometry (API-MS) at intervals of about 20 minutes until oxygen was detected. The amount (milliliter) of oxygen removal per 1 g of the purification agent and the synthetic zeolite was obtained by the foregoing procedure. The results are described in Table 10.

After the detection of oxygen, feeding of inert gas was discontinued and the temperature of the purification agent was raised to 250° C. Then, reproduction of the purification agent was put into practice by passing nitrogen from the side of the synthetic zeolite under atmospheric pressure with a flow rate of 2887 milliliter/minute (LV of 3.0 cm/second) for 1 hour and further passing mixed gas of hydrogen and nitrogen (5% by volume of hydrogen and 95% by volume of nitrogen) under atmospheric pressure with flow rate of 2887 milliliter/minute (LV of 3.0 cm/second) for 5 hours. Consecutively, the purification agent was cooled down to the ordinary temperature. Further, the temperature of the synthetic zeolite was raised to 350° C., a nitrogen gas was passed from side of the purification agent therethrough for 4 hours under atmospheric pressure and at a flow rate of 2887 milliliter/minute (LV of 3.0 cm/second) to effect reproduction of the synthetic zeolite. Consecutively, the synthetic zeolite was cooled down to the ordinary temperature, and thereafter, inert gas purification was started again. The foregoing procedures were carried out repeatedly, and the amount (milliliter) of oxygen removal per 1 g of the purification agent and the synthetic zeolite was obtained in each procedure. The results are described in Table 10.

### Examples 54 to 56

Purification agent were prepared in a similar manner as Example 1 except that the ratio between a number of manganese atom and a number of the entire metallic atoms of the effective component among the resultant purification agent was changed to 50%, 70% or 95% respectively in Examples 54 to 56.

Inert gas purification tests were carried out in the same manner as Example 53 except that the foregoing purification agents were employed in Examples 54 to 56. The results are described in Table 10.

### Example 57

Inert gas purification tests were carried out in a similar manner as Example 53 except that nitrogen containing 50 ppm of carbon dioxide was used as inert gas in Example 57. The results are described in Table 10.

### Examples 58 to 60

Purification agent were prepared in a similar manner as Example 1 except that the ratio between a number of manganese atom and a number of the entire metallic atoms of the effective component among the resultant purification agent was changed to 50%, 70% or 95% respectively in Examples 58 to 60.

Inert gas purification tests were carried out in the same manner as Example 57 except that the foregoing purification agents were employed in Examples 58 to 60. The results are described in Table 10.

### Example 61

Inert gas purification tests were carried out in a similar manner as Example 53 except that inert gas containing 50 ppm of moisture was used as inert gas in Example 61. The results are described in Table 10.

### Examples 62 to 64

Purification agent were prepared in a similar manner as Example 1 except that the ratio between a number of manganese atom and a number of the entire metallic atoms of the effective component among the resultant purification agent was changed to 50%, 70% or 95% respectively in Examples 62 to 64.

Inert gas purification tests were carried out in the same manner as Example 61 except that the foregoing purification agents were employed in Examples 62 to 64. The results are described in Table 10.

TABLE 10
Purification Agent: Manganese Oxide, Vanadium Oxide
and Synthetic Zeolite

| | | | Removed Amount by | | | | |
|---|---|---|---|---|---|---|---|
| | Ratio of | | Purification Agent (ml/g) | | | | |
| | Mn atom | Impurities | First | Second | Third | Fifth | Tenth |
| Ex. 53 | 90% | O₂ | 8.8 | 8.4 | 8.4 | 8.4 | 8.3 |
| Ex. 54 | 50% | O₂ | 4.8 | 4.5 | 4.5 | 4.4 | 4.4 |
| Ex. 55 | 70% | O₂ | 6.6 | 6.3 | 6.3 | 6.3 | 6.3 |
| Ex. 56 | 95% | O₂ | 7.2 | 6.9 | 6.9 | 6.9 | 6.8 |
| Ex. 57 | 90% | CO₂ | 6.5 | 6.1 | 6.1 | 6.1 | 6.1 |
| Ex. 58 | 50% | CO₂ | 3.7 | 3.2 | 3.2 | 3.1 | 3.1 |
| Ex. 59 | 70% | CO₂ | 5.2 | 4.7 | 4.7 | 4.7 | 4.7 |
| Ex. 60 | 95% | CO₂ | 5.9 | 5.6 | 5.6 | 5.5 | 5.5 |
| Ex. 61 | 90% | H₂O | 22.3 | 20.8 | 20.8 | 20.7 | 20.7 |
| Ex. 62 | 50% | H₂O | 20.6 | 19.2 | 19.1 | 19.1 | 19.1 |
| Ex. 63 | 70% | H₂O | 21.1 | 19.9 | 19.8 | 19.8 | 19.7 |
| Ex. 64 | 95% | H₂O | 21.5 | 20.1 | 20.1 | 20.1 | 20.1 |

### Comparative Examples 1 to 3

(Preparation of Purification Agent)

To an aqueous solution of 395 g of potassium permanganate in 12.5 kg of water were promptly added a mixed solution of 15.1 kg of aqueous solution of manganese sulfate in 3% by weight concentration and 144 g of concentrated sulfuric acid to proceed with reaction at the temperature of 70° C. The resultant precipitate was agitated at the temperature of 90° C. for 3 hours, filtered, washed with 25 kg of ion exchanged water three times, filtered again to obtain 1200 g of cakey manganese oxide (MnO₂). The resultant cakey mixed product was dried at the temperature of 90° C. for 12 hours to obtain 360 g of powdery manganese oxide. The BET specific surface area of the resultant powdery manganese oxide measured by means of gas adsorption quantity measuring instrument (“Autosorb 3B” produced by Yuasa Ionics Inc.) was 240 m²/g.

To the resultant powdery manganese oxide in an amount of 100 g were added under kneading 2 g of alumina sol and 40 g of water to obtain a cake, which was extruded with an extruder to obtain a molded product having a diameter of 1.6 mm. The resultant molded product was cut into pieces of about 10 mm in length to obtain pellets. The resultant pellets were dried at the temperature of 120° C. for 12 hours to obtain purification agent. The moisture content in this purification agent was 0.7% by weight.

(Purification Test of Inert Gas)

Inert gas purification tests were carried out in the same manner as Examples 1, 5 and 9 except that the foregoing purification agents were employed in Comparative Examples 1 to 3. The results are described in Table 11.

TABLE 11
Purification Agent: Manganese Oxide

| | Ratio | | | | | | |
|---|---|---|---|---|---|---|---|
| | of Mn | Impur- | Removed Amount by Purification Agent (ml/g) | | | | |
| | atom | ities | First | Second | Third | Fifth | Tenth |
| Com. | 100% | O₂ | 1.6 | less | less | less | less |
| Ex. 1 | | | | than 1 | than 1 | than 1 | than 1 |
| Com. | 100% | CO₂ | 1.4 | less | less | less | less |
| Ex. 2 | | | | than 1 | than 1 | than 1 | than 1 |
| Com. | 100% | H₂O | 1.4 | less | less | less | less |
| Ex. 3 | | | | than 1 | than 1 | than 1 | than 1 |

### Comparative Examples 4 to 6

Inert gas purification tests were carried out in the same manner as Examples 1, 5 and 9 except that the marketed vanadium oxide (V₂O₅) catalyst was employed as purification agent in Comparative Examples 4 to 6. The results are described in Table 12.

TABLE 12
Purification Agent: Vanadium Oxide

| | | Removed Amount by Purification Agent (ml/g) | | | | |
|---|---|---|---|---|---|---|
| | Impurities | First | Second | Third | Fifth | Tenth |
| Com. Ex. 4 | O₂ | less | less | less | less | less |
| | | than 1 | than 1 | than 1 | than 1 | than 1 |
| Com. Ex. 5 | CO₂ | less | less | less | less | less |
| | | than 1 | than 1 | than 1 | than 1 | than 1 |
| Com. Ex. 6 | H₂O | less | less | less | less | less |
| | | than 1 | than 1 | than 1 | than 1 | than 1 |

### Comparative Examples 7 to 9

Inert gas purification tests were carried out in the same manner as Examples 1, 5 and 9 except that the marketed catalyst (Hopcalite) containing manganese oxide (MnO₂) and copper oxide (CuO) as effective component with weight ratio of 6:4 was employed as purification agent in Comparative Examples 7 to 9. The results are described in Table 13.

TABLE 13
Purification Agent: Hopcalite

| | | Removed Amount by Purification Agent (ml/g) | | | | |
|---|---|---|---|---|---|---|
| | Impurities | First | Second | Third | Fifth | Tenth |
| Com. Ex. 7 | O₂ | 3.1 | less | less | less | less |
| | | | than 1 | than 1 | than 1 | than 1 |
| Com. Ex. 8 | CO₂ | 1.8 | less | less | less | less |
| | | | than 1 | than 1 | than 1 | than 1 |
| Com. Ex. 9 | H₂O | 2.5 | less | less | less | less |
| | | | than 1 | than 1 | than 1 | than 1 |

### Comparative Examples 10 to 12

Inert gas purification tests were carried out in the same manner as Examples 1, 5 and 9 except that the marketed nickel catalyst was employed as purification agent in Comparative Examples 10 to 12. The results are described in Table 14.

TABLE 14
Purification Agent: Metallic Nickel

| | | Removed Amount by Purification Agent (ml/g) | | | | |
|---|---|---|---|---|---|---|
| | Impurities | First | Second | Third | Fifth | Tenth |
| Com. Ex. 10 | O₂ | 9.1 | 8.7 | 8.7 | 8.7 | 8.7 |
| Com. Ex. 11 | CO₂ | less | less | less | less | less |
| | | than 1 | than 1 | than 1 | than 1 | than 1 |
| Com. Ex. 12 | H₂O | less | less | less | less | less |
| | | than 1 | than 1 | than 1 | than 1 | than 1 |

According to the process for purifying inert gas of the present invention, a slight amount of impurities such as oxygen, carbon monoxide, carbon dioxide and moisture contained in inert gas was became to be removable to an extent extremely great amount as compared with the conventional purification process under a converted removed amount per unit amount of the purification agent. Additionally, any repeated reproduction of the purification agent does not reduce the capability of removing impurities in inert gas, and the longevity of the purification agent was remarkably elongated than the conventional purification process.

What is claimed is:

1. A process for purifying inert gas removing at least one kind of impurities selected from oxygen, carbon dioxide and moisture contained in the inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component.

2. A process for purifying inert gas removing at least one kind of impurities selected from oxygen, carbon dioxide and moisture contained in the inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component; and with a synthetic zeolite.

3. A process for purifying inert gas removing at least one kind of impurities selected from oxygen, carbon dioxide and moisture contained in the inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component; and further reproducing the purification agent by contacting a reproduction gas with the purification agent.

4. A process for purifying inert gas removing at least one kind of impurities selected from oxygen, carbon dioxide and moisture contained in the inert gas which comprises contacting the inert gas with a purification agent comprises: a manganese oxide, and at least one kind of metal oxide selected from vanadium oxide, chromium oxide, iron oxide, tin oxide, zirconium oxide, bismuth oxide, niobium oxide and tantalum oxide as an effective component; and with a synthetic zeolite; further reproducing the purification agent and the synthetic zeolite by contacting a reproduction gas with the purification agent and the synthetic zeolite.

5. The process for purifying inert gas according to any one of claims 1 to 4, wherein a ratio between a number of manganese atom and a number of the entire metallic atoms of the effective component is 80 to 99%.

6. The process for purifying inert gas according to any one of claims 1 to 4, wherein the content of said effective component is usually at least 70% by weight in the entire purification agent.

7. The process for purifying inert gas according to any one of claims 1 to 4, wherein said manganese oxide is MnO, Mn₃O₄, Mn₂O₃ or MnO₂.

8. The process for purifying inert gas according to any one of claims 1 to 4, wherein said purification agent is prepared by mixing solution containing manganese and solution containing at least one metal selected from vanadium, chromium, iron, tin, zirconium, bismuth, niobium and tantalum; coprecipitating to obtain precipitate; filtering and drying the resultant precipitate.

9. The process for purifying inert gas according to any one of claim 2 or claim 4, wherein said synthetic zeolite has a pore diameter in the range of 3 to 10 Å.

10. The process for purifying inert gas according to any one of claims 1 to 4, wherein said inert gas is at least one selected from helium, nitrogen, neon, argon, krypton and xenon.

11. The process for purifying inert gas according to claim 3 or claim 4, wherein said reproducing is carried out by feeding an inert gas to said purification agent and subsequently by feeding hydrogen.

12. The process for purifying inert gas according to any one of claims 1 to 4, wherein a temperature contacting said inert gas with said purification agent is lower than 150° C.

13. The process for purifying inert gas according to claim 2 or claim 4, wherein a temperature contacting said inert gas with said synthetic zeolite is lower than 150° C.

14. The process for purifying inert gas according to claim 3 or claim 4, wherein a temperature for reproducing said purification agent is 150 to 400° C.

15. The process for purifying inert gas according to claim 4, wherein a temperature for reproducing said synthetic zeolite is 150 to 350° C.

16. The process for purifying inert gas according to claim 3, wherein the purification of inert gas is intermittently carried out by deploying at least two lines of purification line containing the purification agent in order to supply highly pure inert gas continuously; and wherein the purification agent is intermittently reproduced by supplying a reproduction gas to the latter part of the purification line.

17. The process for purifying inert gas according to claim 4, wherein the purification of inert gas is intermittently carried out by deploying at least two lines of purification line containing both the purification agent and the synthetic zeolite in order to supply high purity inert gas continuously; and wherein the purification agent and the synthetic zeolite are intermittently reproduced by supplying a reproduction gas to the latter part of the purification line.
